(19) United States
(12) Patent Application Publication
(10) Pub. No.: US 2009/0007431 A1
(43) Pub. Date: Jan. 8, 2009

(54) METHOD OF MANUFACTURING DENTAL INSTRUMENTS FROM SUPER-ELASTIC ALLOYS

(75) Inventor: Dan E. Fischer, Sandy, UT (US)

Correspondence Address: Workman Nydegger;1000 Eagle Gate Tower, 60 East South Temple, Salt Lake City, UT, 84111, US

(73) Assignee: Ultradent Products, Inc., South Jordan, UT (US)

(21) Appl. No.: 12/210,539

(22) Filed: Sep. 15, 2008

Related U.S. Application Data
(62) Division of application No. 11/176,839, filed on Jul. 7, 2005.
(60) Provisional application No. 60/586,738, filed on Jul. 9, 2004.

(51) Int. Cl. B23P 13/00

(52) U.S. Cl. 29/896.1

(57) ABSTRACT

Dental instruments and appliances are manufactured from a superelastic alloy, which includes atoms from the group IV_{B} and group V_{B} transition metals and oxygen so as to exhibit superior strength and flexibility. The metal alloys are cold worked to increase the tensile strength of the dental instruments and appliances. Cold working the metal also increases the flexibility of the dental instruments and appliances and prevents work hardening. Dental instruments made from the superelastic alloy exhibit higher strength, flexibility, resistance to work hardening, and biocompatibility compared to dental instruments made from nickel-titanium alloys. In one particular example a super-elastic endodontic file is described.

### CROSS-REFERENCE TO RELATED APPLICATION

This application is a division of U.S. application Ser. No. 11/176,839, filed Jul. 7, 2005, which claims the benefit under 35 U.S.C. § 119 of U.S. provisional application Ser. No. 60/586,738, filed Jul. 9, 2004. The disclosures of the foregoing applications are incorporated herein in their entirety.

### BACKGROUND OF THE INVENTION

1. The Field of the Invention

The present invention is in the field of dentistry and is related to dental instruments such as endodontic files and burrs. More particularly, the invention relates to dental instruments and dental appliances formed from metal alloys of group IV and group V transition metals.

2. Related Technology

The use of dental cutting instruments to abrade teeth has existed since modern dental techniques have been employed. For instance, various dental procedures often require the use of a drill, burr, or file. For several reasons, there exists a particular need to have high performance dental instruments. Often, a person's mouth and the spacing between ones teeth create a difficult environment to work in. Consequently, dental instruments often need to be compact, strong, and biocompatible. Furthermore, both patients and dentists place a premium on performing dental procedures quickly and accurately.

Root canal procedures provide a particularly challenging dental procedure that requires a dental cutting instrument. A root canal procedure can be necessary when the root of a tooth dies. Rather than pull a dead tooth, a practitioner will often bore out the dead root and fill the root canal with a filling material such as gutta percha. Removing all the pulp and properly cleaning the root canal are important steps to prevent disease and ensure proper healing of the tooth.

Preparing a root canal is typically achieved using a file or bit that is configured to bore or cut. FIG. 1, shows an endodontic file 110 disposed in a root canal 112 of a tooth 114. Tooth 114 has an outer enamel layer 116, and an inner dentin layer 118, which forms root canal 112. Endodontic file 110 has an abrading surface 120. Abrading surface 120 is moved up and down and rotated within root canal 112 to remove pulp 122 therefrom.

The stiffness of endodontic file 110 greatly affects the ability of endodontic file 110 to properly bore or cut pulp 122 in the root canal. Because portions of root canal 112 are narrow and curved, it is difficult for a stiff file, such as endodontic file 110 to remove pulp from the inside wall of root canal 112. In some cases, as shown in FIG. 1, endodontic file 110 can cut an unintended ledge 124 into the wall of root canal 112. Ledge 124 can occur when a practitioner attempts to insert a file such as file 110 as far as the apex 126 and the file is too inflexible to properly curve with the root canal or move around a protrusion. When a file is too inflexible to curve or flex as needed and is halted prematurely, the downward pressure exerted on the file, in conjunction with the tendency of the file to straighten itself, causes the tip of the file to dig into the side of the root canal 112 and form ledge 124. Such ledges are difficult to bypass, and if the ledge occurs very close to the apex, the ledge may give the practitioner the mistaken impression that the apex has been reached.

Another problem with a stiff endodontic file is the tendency of the file to abrade more of the root canal than necessary. As the file is forced down the root canal, pressure from the root canal wall causes the file to bend. A stiffer file creates more friction between the root canal wall and the file. The greater force caused by curves in the root canal can cause the file to abrade these sections of the root canal wall more than other sections. If too much of the root canal wall is abraded, the tooth is weakened and the tooth can fail.

Some existing endodontic files have been made thinner or made with more elastic materials to give the file more flexibility. However, making the file thinner affects the strength of the file. A weak file can break causing serious injuries and complications with a dental procedure. Some materials can provide the necessary flexibility, but are not suitable as an endodontic file because they cannot keep a good edge or are not biocompatible.

Recently, endodontic files have been made from various nickel-titanium alloys, which exhibit more flexibility and hardness. Despite recent advancements with using nickel-titanium alloys, existing endodontic files are still stiffer and weaker than desirable and may experience work hardening if repeatedly flexed during use. Files with a desired thickness often do not have the needed flexibility to properly curve within a root canal or are too week and thus break. Furthermore, existing endodontic files still wear faster than preferred.

Other dental cutting instruments, such as dental burrs and drills are also limited by their composition. For instance, drill bits and dental burrs made of steel or other materials wear quickly and/or break easily. Screw implants and posts are susceptible to breakage. Dental instruments such as orthodontic brackets, ligature wires, matrix bands and other instruments, are bulky or have the potential to break. Furthermore, many dental appliances and instruments use nickel-based metals, which are known to be bio-incompatible to some extent.

Therefore, what is needed are dental cutting instruments and dental instruments that overcome the disadvantages of the inflexible, weak, and bio-incompatible dental instruments and appliances that exist in the prior art.

### BRIEF SUMMARY OF THE INVENTION

The present invention overcomes the aforementioned problems in the prior art by providing dental instruments and appliances made from super-elastic alloys. The dental instruments and appliances exhibit toughness and durability because of their high tensile strength. The dental instruments and appliances also exhibit superior flexibility giving them unique properties and reducing breakage caused by cold-working.

In an exemplary embodiment of the present invention, a dental cutting instrument is provided for abrading a tooth. The dental cutting instrument includes a shank that has an outer periphery surface. A portion of the periphery surface forms an abrading segment. The abrading segment is configured for abrading a dental material such as enamel, dentin, pulp and the like. The shank includes a metal alloy comprising at least one group IV_{B} transition metal, at least one group V_{B} transition metal, and oxygen. The metal alloy is also cold worked, thereby increasing the tensile strength and decreasing the elastic modulus of the metal alloy.

In one embodiment, the dental instruments and appliances of the present invention are formed by combining proper molar ratios of pure titanium powder and other alloying elemental powders such as zirconium, vanadium, niobium, and tantalum. At least some of the metal powders or another added constituent contains oxygen. The blended powders are compacted in a cold isostatic press and sintered in a vacuum. The sintered material is then hot forged, hot rolled, solution treated in an inert gas, and quenched in brine. Finally, the metal alloy is cold worked to increase its strength and flexibility.

Additional processing steps are used to form various different types of dental cutting instruments and instruments. For example an endodontic file can be made by cold working the metal alloy to form an elongate shaft and then grinding the shaft to produce a file. In another exemplary embodiment, orthodontic brackets, posts, and matrix bands, are formed by a cold swaging processes and/or further grinding.

Dental cutting instruments and instruments according to the present invention have advantages over dental cutting instruments and instruments in the prior art. For instance, the endodontic files of the present invention have superior flexibility and hardness, which allows a practitioner to better prepare a root canal. The hardness of the super-elastic alloy allows thinner, more delicate files to be made without compromising strength and wear. Alternatively, if a thicker file is desired, the thicker file can be made with greater elasticity.

Other dental instruments or appliances, such as matrix bands, orthodontic brackets, arch wires, and rubber dam clamps, can be made thinner and lighter because of the superior strength of the alloy material. In addition, the super-elastic properties of the alloy help prevent breakage caused by cold working.

These and other features of the present invention will become more fully apparent from the following description and appended claims.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a longitudinal cross-sectional view of a tooth depicting ledging during cleaning of the root canal using a dental cutting instrument of the prior art;

FIG. 2 is an elevational view of an exemplary endodontic file according to the present invention;

FIG. 3 is a cross-sectional view of the endodontic file of FIG. 2;

FIG. 4 is a longitudinal cross-sectional view of a tooth with the endodontic file of claim 2 inserted into the root canal to the apical end;

FIG. 5 is an elevational view of an exemplary round burr according to the present invention;

FIG. 6 is a longitudinal cross-sectional view of a tooth with the round burr of FIG. 4 being used to remove the enamel and dentin above the root;

FIG. 7 is an elevational view of an exemplary finishing file according to the present invention;

FIG. 8 is an elevational view of an exemplary drill according to the present invention;

FIG. 9 is an elevational view of an exemplary abrasive disk according to the present invention;

FIG. 10 is an elevational view of an exemplary post according to the present invention;

FIG. 11 is an elevational view of an exemplary interproximal guard according to the present invention;

FIG. 12 is an elevational view of an exemplary rubber dam clamp according to the present invention;

FIG. 13 is an elevational view of an exemplary matrix band according to the present invention; and

FIG. 14 is an elevational view of an exemplary orthodontic system according to the present invention.

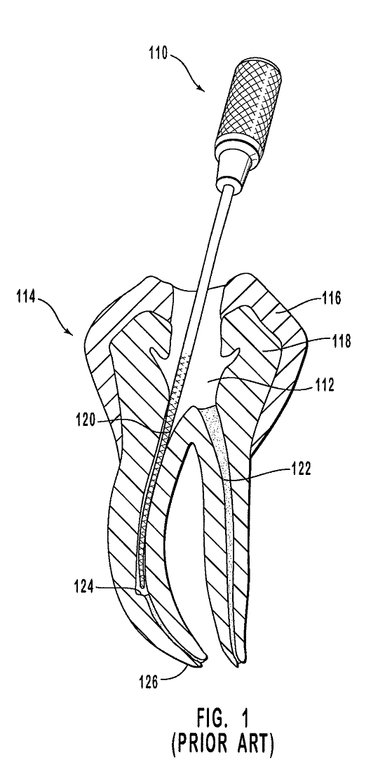

### DETAILED DESCRIPTION OF EXEMPLARY EMBODIMENTS

The present invention relates generally to improved dental instruments and appliances, such as dental cutting instruments. In an exemplary embodiment, the dental cutting instruments of the present invention include dental drills, files, burrs and wheels. The dental cutting instruments are configured to cut or bore dental tissue such as bone, enamel, dentin, or pulp. At least a portion of the dental cutting instrument is formed from the alloys of the present invention. The dental instruments and appliances of the present invention may be configured for hand use or for use with another dental instrument such as a reciprocating tool.

In another embodiment, the dental instruments and appliances of the present invention are not configured to cut. For example, instruments and appliances such as matrix bands, orthodontic brackets, arch wires, rubber dam clamps, and the like can made from the flexible alloys according to the present invention.

### I. Super-Elastic Alloy

The dental instruments and appliances of the present invention are made from a super-elastic alloy, which gives the instrument strength and flexibility. The super-elastic alloy comprises metal atoms selected from group IV and V transition metals and oxygen. In a preferred embodiment, the alloy is substantially free of nickel, insofar as nickel has been shown to be bio-incompatible. In yet another exemplary embodiment, substantially all of the metal alloys comprise group IV_{B} and V_{B} transition metals and oxygen. A description of exemplary super-elastic titanium alloys that may be used to manufacture dental instruments and appliances within the scope of the invention are disclosed in U.S. Patent Publication No. 2004/0115083, which is incorporated herein by reference.

In one embodiment, super-elastic alloys contain combinations of titanium (Ti), zirconium (Zr), tantalum (Ta), niobium (Nb), vanadium (V), and hafnium (Hf). In a preferred embodiment, titanium is included in a molar concentration of less than about 35 mole percent, more preferably less than about 15 mole percent, and most preferably less than about 5 mole percent.

Oxygen (O) is included in a concentration of about 0.1 to about 15 mole percent. More preferably, Oxygen concentration is about 0.5 to about 10 mole percent and even more preferably between about 0.7 to about 4 mole percent. It is believed that oxygen is important for binding to zirconium to form Zr—O clusters that prevent dislocation activity, thus creating plasticity in the cold worked metal.

The super-elastic metal alloys that make up the dental instruments of the present invention have combinations of group IV_{B} and group V_{B} transition metals and oxygen in particular mole ratios to produce a metal with the desired properties. Mole concentrations are selected such that the metal alloys have the following characteristics: (i) a compositional average valence electron number of about 4.24; (ii) a bond order of about 2.87; and (iii) a “d” electron-orbital energy level of about 2.45 eV. Examples of alloy compositions that satisfy the above mentioned properties include alloys having formulas of 1Ti-12Ta-9Nb-3V-6Zr-1O and 1Ti-23Nb-0.7Ta-2Zr-1O (mole percent).

The super-elastic alloys of the present invention are also cold worked to increase strength and flexibility. Like most metals, the super-elastic alloys of the present invention become stronger with cold working, such as swaging. Unlike most other metals, however, the super-elastic alloys of the present invention become more flexible with cold working. Cold working the alloys of the present invention prevents work hardening and reduces the elastic modulus, which provides an unexpected advantage over dental instruments made from nickel-titanium alloys, which can experience work hardening. In an exemplary embodiment, the super-elastic alloys of the present invention are cold worked by swaging with about a 25 percent reduction in area. In a more preferred embodiment, cold swaging is performed with about a 50 percent reduction in area. Even more preferred is cold swaging with a about a 75 percent reduction in area and most preferred is cold swaging with about a 90 percent reduction in area.

In one embodiment, the dental instruments of the present invention are formed by first combining proper molar ratios of alloying elemental powders, such as titanium, zirconium, vanadium, niobium, and tantalum. At least some of the metal powders, or another added constituent, contains oxygen.

The blended powders are then compacted in a cold isostatic press and sintered in a vacuum. The sintered material is then hot forged, hot rolled, solution treated in an inert gas, and quenched in brine. Finally, the metal alloy is cold worked to increase its strength and flexibility.

By way of a specific example, a dental instrument according to the present invention is formed from an alloy wherein the alloy if formed as follows: An amount of alloying powders, in the molar ratios of 1Ti-12Ta-9Nb-3V-6Zr-1.5O, are blended in an attrition mixer for 30 min. Oxygen content is controlled by using high-oxygen-content titanium powder having 4 mole percent oxygen. The blended powders are compacted in a cold isostatic press at about 400 MPa, and sintered at 1300° C. for 4 hours in a vacuum of 10-3 Pa. The sintered ingot is hot forged at 1150° C. and hot rolled at 800° C. to form a bar. The bar is then solution treated in argon for 1 hour at 1000° C. Finally, the bar is quenched in brine and cold worked by swaging to form a particularly shaped, cold-worked metal alloy. The swaging process can be used to give the metal alloy a preliminary desired shape. For instance, if a rod like dental instrument or appliance is desired, such as a file, burr, or arch wire, the metal alloy can be shaped by rotary swaging. In other instances, such as with an abrasive disk, the backing for the disk is formed by flat rolling.

Once the metal alloy is formed to a particular shape, additional processing steps can be used to form various different types of dental instruments and appliances. For example an endodontic file can be made by grinding, cutting or chemically etching a rod of metal alloy. Methods for chemical etching that can be used with the present invention to make an endodontic file are disclosed in U.S. application Ser. No. 10/436,938, entitled “METHODS FOR MANUFACTURING ENDODONTIC INSTRUMENTS,” filed May 13, 2003, and U.S. application Ser. No. 10/991,178, entitled “METHODS FOR MANUFACTURING ENDODONTIC INSTRUMENTS,” filed Nov. 17, 2004, this disclosures of which are herein incorporated by reference.

### II. Dental Cutting Instruments

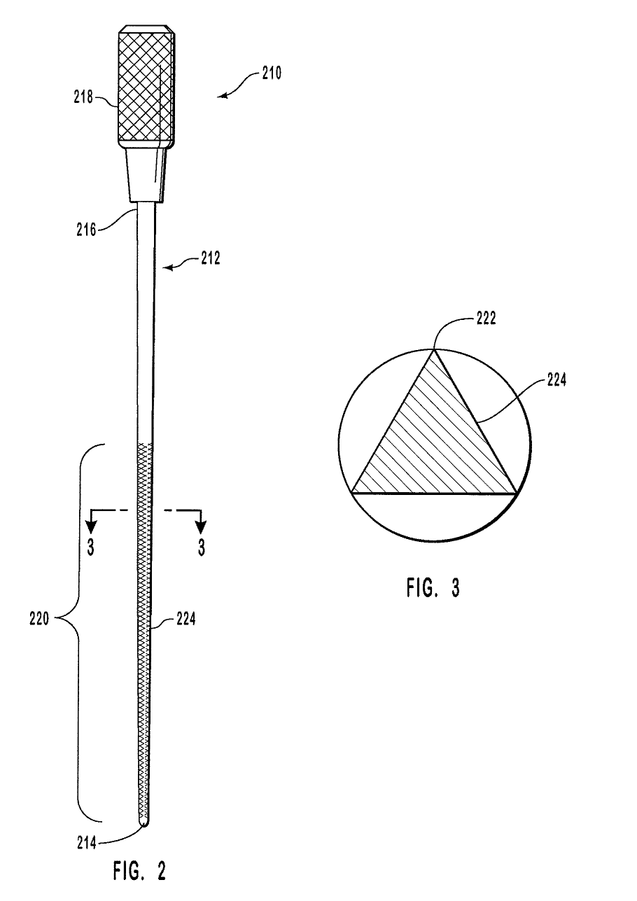

With reference now to FIG. 2, in one embodiment, a dental cutting instrument according to the present invention is an endodontic file 210. Endodontic file 210 has a handle 218 and a shaft 212. Shaft 212 extends between a distal end 214 and a proximal end 216 and has a periphery surface.

Shaft 212 typically has a diameter between about 0.5 and about 1.6 mm and a length of about 30 mm. Shaft 212 can be formed to have a desired shape. Shaft 212 can be cylindrical or it can be slightly tapered toward distal end 214, as illustrated in FIG. 2. The taper can be any amount desired, but is typically between about 0.02 mm/mm and about 0.06 mm/mm. The specific taper of endodontic file 210 will depend on the intended use and dental practitioner's preference. Alternatively, the shaft can have a uniform width from the proximal end to the distal end.

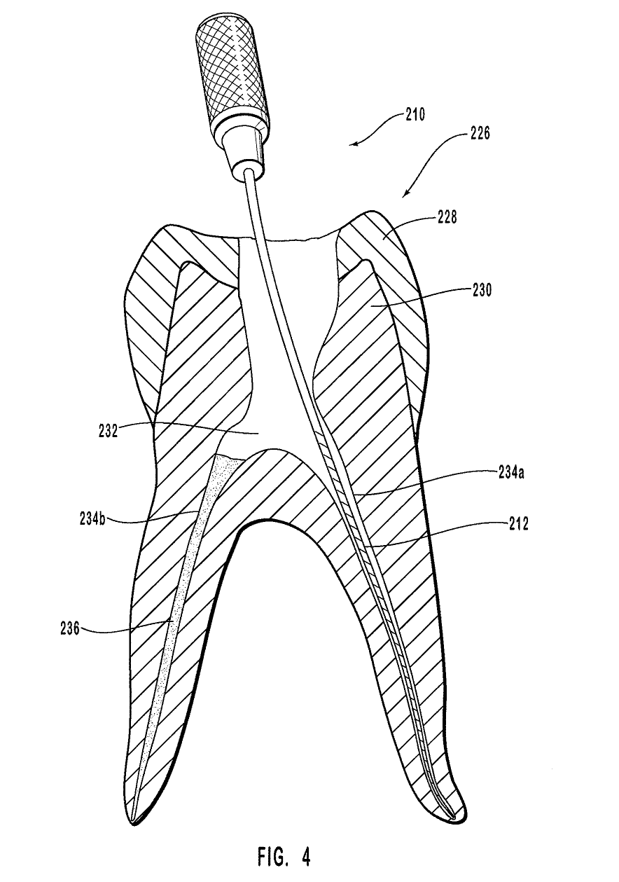

The length of shaft 212 should be sufficient to extend a desired distance within the root canal of a tooth. The shaft 212 may extend the entire length of a root canal as illustrated in FIG. 4.

Handle 218, at proximal end 216, helps a user grip endodontic file 210. Handle 218 can be configured for manual use or for use in a dental hand piece such as a reciprocating hand piece.

A portion of the periphery surface of shaft 212 forms an abrading segment 220, which is disposed between distal end 214 and proximal end 216. Abrading segment 220 can have a length of about 2 mm up to about the entire length of shaft 212. It will be appreciated that abrading segment 220 can terminate before reaching distal end 214, as in a coronal file, or it can be a small length near distal end 214, as in an apical file.

As shown in FIG. 3, in one exemplary embodiment, the cross-sectional configuration of abrading segment 220 is triangular. The apices 222 form helical cutting edges 224. Abrading segment 220 can have any polygonal cross-section such that when shaft 212 is ground or twisted, helical cutting edges 224 are formed. In one embodiment, one or more flutes formed in abrading segment 220 form helical cutting edges 224. In an alternative embodiment, the shaft has a different polygonal cross-sections and a different cutting edge. For example, a shaft having a square cross section forms four helical cutting edges.

Shaft 212 comprises a super-elastic alloy according to the present invention. As discussed above, the super-elastic alloy can include titanium, zirconium, one or more group V_{B} metals, and oxygen. The super-elastic metal making up shaft 212 is cold worked by swaging to increase its strength and elasticity.

In one embodiment, to form the shaft 212, the metal alloy is rotary swaged to form a thin rod or wire of about 7 mm in diameter. The rod or wire is then ground using traditional techniques to form abrading segment 220. The abrading segment can be formed using other methods such as cutting, twisting, chemical etching and the like or combinations of the above.

Depending on the desired effect, a portion of or all of shaft 212 can be made from the super-elastic alloys of the present invention. In an exemplary embodiment the entire shaft 212, including abrading segment 220 is made from substantially cold worked alloys of the present invention.

Making shaft 212 from the present alloys provides for a very flexible endodontic file 210. Both the characteristic of low elastic modulus and high tensile strength contribute to the flexibility of shaft 212. Obviously, the lower the elastic modulus of shaft 212, the greater the flexibility. In addition, because of the strength of shaft 212, shaft 212 can be made very thin. In most cases, a thinner shaft 212 gives endodontic file more flexibility. Even where a file with a larger diameter is preferred, the flexibility of shaft 212 allows for larger diameter files with a given flexibility as compared to prior art files. In addition, because shaft 212 is so strong, abrading segment 220 will better hold cutting edges 224, thereby significantly increasing the durability of endodontic file 210.

FIG. 4 shows endodontic file 210 disposed in tooth 226. The enamel 228 and dentin 230 above pulp chamber 232 is removed to provide access to root canals 234a and 234b. Root canal 234b is shown with its pulp 236 remaining. Endodontic file 210 is disposed within root canal 234a. Root canal 234a has had its pulp removed and wall reshaped by endodontic file 210. To remove the pulp and reshape the wall, endodontic file 212 is moved longitudinally and rotated within root canal 234a. Removing the pulp and reshaping the wall of root canal 234a prepares it for receiving a filling material such as gutta percha.

As illustrated in FIG. 4, the elasticity of endodontic file 210 allows endodontic file 210 to bend with the natural curvature of root canal 234a. The low elastic modulus of shaft 212 allows shaft 212 to bend given relatively little applied force. Because less force is required to bend shaft 212, the restoring force of shaft 212 against root canal 234a is correspondingly less. In addition, the smaller restorative force causes shaft 212 to more evenly abrade root canal 234a and reduces the risk that shaft 212 will form ledges or otherwise misshape root canal 234a. In addition, the elasticity of shaft 212 makes it less likely that endodontic file 210 will break or permanently deform, which would require replacement.

Turning now to FIG. 5, in an alternative embodiment, the dental cutting instrument of the present invention is a dental burr 310. Dental burr 310 includes shaft 312 extending between distal end 314 and proximal end 316 and having a periphery surface. The periphery surface at distal end 314 forms a ball-shaped abrasive segment 318. Dental burr 310 can be configured for manual use or use with a hand piece such as a reciprocating hand piece.

Abrasive segment 318 has particles 320 disposed thereon for cutting a tooth material such as enamel or dentin. In an exemplary embodiment, particles 320 are secured to abrasive segment 318 using an adhesive. Particles 320 are typically a very hard substance such as diamond or carbide. The shape of abrasive segment 320 can be rounded, conical, blunt, sharp, or any other desired shape configured for cutting a tooth material.

Shaft 312 of dental burr 310 is made from the super-elastic alloys of the present invention. As discussed above, the present alloys include atoms from the group IV_{B} and group V_{B} transition metals and oxygen. Shaft 312 is cold worked to increase tensile strength and elasticity. Alloys of the present invention can be used to make the entire shaft 312. Alternatively, a portion of shaft 312, such as abrasive segment 318, can be made using the alloys of the present invention.

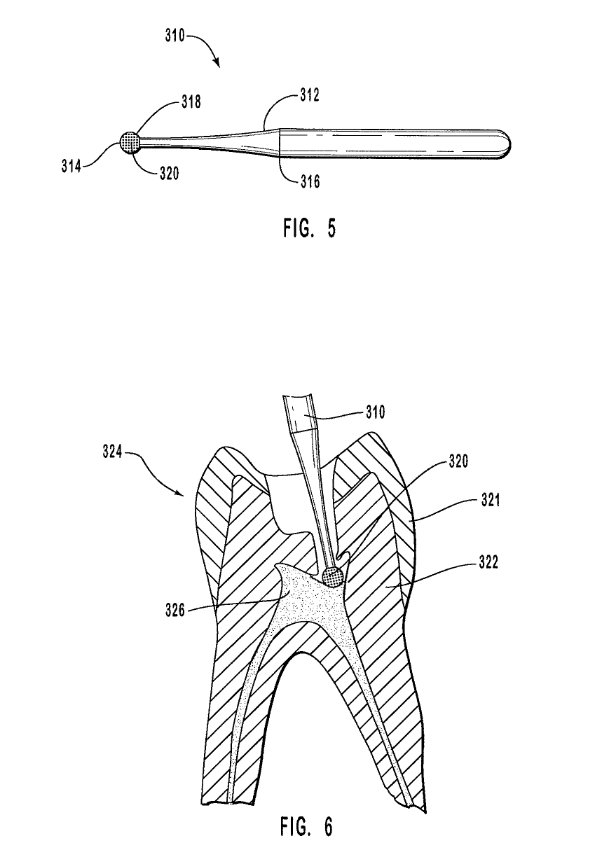

FIG. 6 shows dental burr 310 cutting tooth 324. Particles 320 of abrading segment 318 are configured to cut through the enamel 321 and dentin 322 of tooth 324. Dental burr 310 can be used to open tooth 324 to provide access to pulp chamber 326. The amount of flexibility in dental burr 310 is controlled by selecting the thickness and shape of shaft 312. While dental burr 310 has been illustrated as an endodontic instrument, dental burr 310 can be designed according to the present invention for use outside the tooth.

Dental burr 310 is made from the present alloys such that dental burr 310 can flex without work hardening. A practitioner using dental burr 310 to cut tooth 320 often must apply a force to dental burr 310 that can cause dental burr 310 to flex. The unique properties of dental burr 310 allows dental burr 310 to flex without work hardening or permanently deforming.

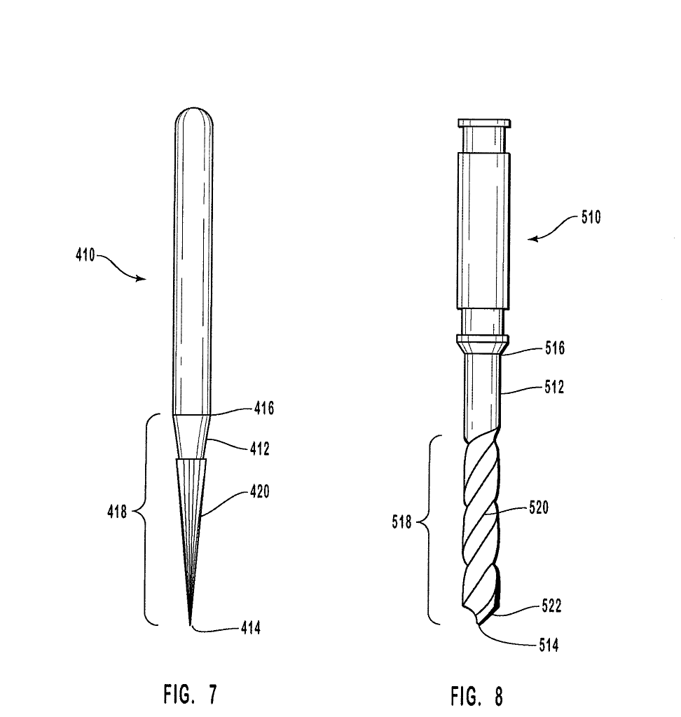

Turning now to FIG. 7, in another alternative embodiment, the dental cutting instrument of the present invention is a finishing file 410. Finishing file 410 includes shaft 412 extending between distal end 414 and proximal end 416 and having a periphery surface. The periphery surface between distal end 414 and proximal end 416 forms an abrasive segment 418. Finishing file 410 can be configured for manual use or use with a hand piece such as a reciprocating hand piece.

Shaft 412 of finishing file 410 is made from the super-elastic alloys of the present invention. As discussed above, the present alloys include atoms from the group IV_{B} and group V_{B} transition metals and oxygen. Shaft 412 is cold worked to increase tensile strength and elasticity. Alloys of the present invention can be used to make the entire shaft 412. Alternatively, a portion of shaft 412, such as abrasive segment 418 can be made from the present alloys.

Abrasive segment 418 has flutes 420 that form a cutting edge. The shape of abrasive segment 418 and the design of flutes 420 can be configured for a particular dental procedure. Abrasive segment 418 can be rounded, conical, blunt, sharp, or any other desired shape that gives a practitioner access to a particular tooth material or provides a desired cutting surface for cutting a tooth material. Likewise, flutes 420 can have any desired configuration. For instance, in an alternative embodiment, the abrasive segment has flutes that spiral around shaft 412 such that finishing file 410 can cut when reciprocating or moving up and down.

Shaft 412 is made from the alloys of the present invention such that finishing file 410 is very hard and flexible. The hardness of shaft 412 allows abrasive segment 418 to maintain a good cutting edge. Consequently, finishing file 410 is very durable. The flexibility of finishing file 410 can prevent work hardening and gives finishing file 410 agility for reaching and contacting various tooth surfaces.

As shown in FIG. 8, in yet another alternative embodiment, the dental cutting instrument of the present invention is a drill 510. Drill 510 includes shaft 512 extending between distal end 514 and proximal end 516 and having a periphery surface. The periphery surface forms an abrasive segment 518. Drill 510 is typically configured for use with a reciprocating hand piece.

Shaft 512 of drill 510 is made from the super-elastic alloys of the present invention. As discussed above, the present alloys include atoms from the group IV_{B} and group V_{B} transition metals and oxygen. Shaft 512 is cold worked to increase tensile strength and elasticity.

Abrasive segment 518 has helical flutes 520 that form a cutting edge. A leading edge 522 is configured to cut or bore through a dental material. The flexibility and hardness of shaft 512 gives drill 510 exceptional durability and reduces the adverse effects created by work hardening.

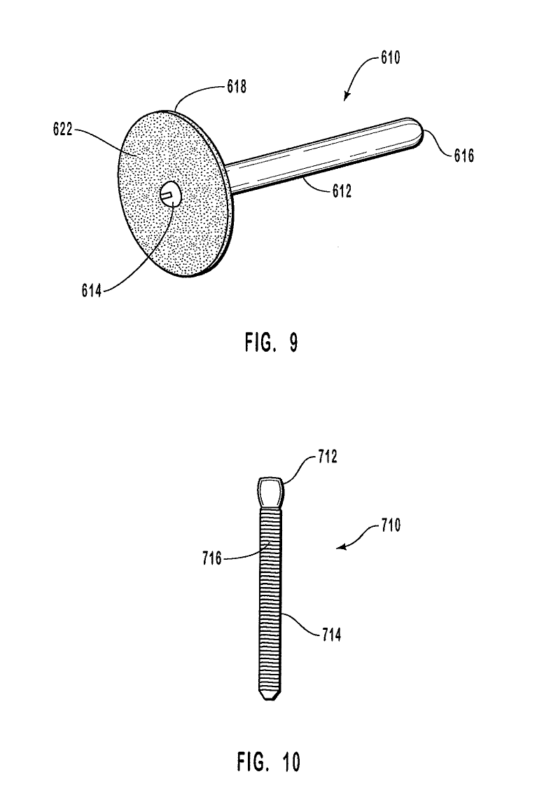

Turning now to FIG. 9, in yet another alternative embodiment, the dental cutting instrument of the present invention is an abrasive disk 610. Abrasive disk 610 includes shaft 612 extending between distal end 614 and proximal end 616 and having a periphery surface. At distal end 614 a backing in the shape of a wheel forms abrasive segment 620. Abrasive segment 620 is secured to abrasive disk 610 with a screw.

Abrasive segment 620 has particles 622 disposed thereon for cutting a dental material. In an exemplary embodiment, particles 622 are secured to abrasive segment 620 using an adhesive. Particles 622 are typically a very hard substance such as diamond or carbide.

In an exemplary embodiment, the wheel that forms abrasive segment 620 is made from the alloys of the present invention. Constructing abrasive segment 620 from the present alloys allows abrasive segment 620 to be very thin. The thinness of abrasive segment 620 allows the abrasive disk 610 to abrade dental material in gaps that would otherwise be inaccessible. In addition, abrasive segment can flex without work hardening or breaking under the forces applied during use. Shaft 612 can also be made of the alloys of the present invention.

Exemplary methods for manufacturing endodontic instruments, including files, are set forth in U.S. Pat. No. 4,934,934, U.S. Pat. No. 5,653,590, U.S. Pat. No. 5,762,541, U.S. application Ser. No. 11/063,354, filed Feb. 23, 2005, and U.S. application Ser. No. 11/063,757, filed Feb. 23, 2005, the disclosures of which are incorporated by reference.

### III. Non-Cutting Dental Instruments and Appliances

The dental instruments and appliances of the present invention are not limited to dental cutting instruments. FIGS. 10-14 illustrate alternative non-cutting embodiments of the present invention that employ the alloys of the present invention. The non-cutting dental instruments have a body portion that is made from the super-elastic alloys of the present invention. As discussed above, the present alloys include atoms from the group IV_{B} and group V_{B} transition metals and oxygen. The alloys that form the non-cutting dental instruments and appliances are cold worked to increase tensile strength and elasticity.

FIG. 10 illustrates an exemplary dental implant, such as post 710, made from the present alloys. Post 710 has a head 712 and a shank 714. Shank 714 has horizontal groves 716, which provide a gripping surface for fixing post 710 to bone.

Post 710 is configured to be embedded or adhered to a bone, such as a jawbone. Post 710 serves as an anchor for the attachment of a dental prosthetic appliance, such as a crown, a denture, a partial denture or a bridge. Other exemplary dental implants of the present invention include implant screws and the like.

The dental implants of the present invention, such as post 710 are made from the alloys of the present invention. The dental implants can be designed to be very strong and small because of the beneficial characteristics of the present alloys as described above. The small and strong characteristics of the dental implants of the present invention are very advantageous because of the small area where the dental implants must be implanted and the tremendous forces that the dental implants must withstand.

In one embodiment of the present invention, the dental implants of the present invention do not contain nickel. The dental implants of the present invention are improved over the prior art because they are very strong and small, yet do not contain nickel, which is known to be incompatible with biological systems to a certain extent.

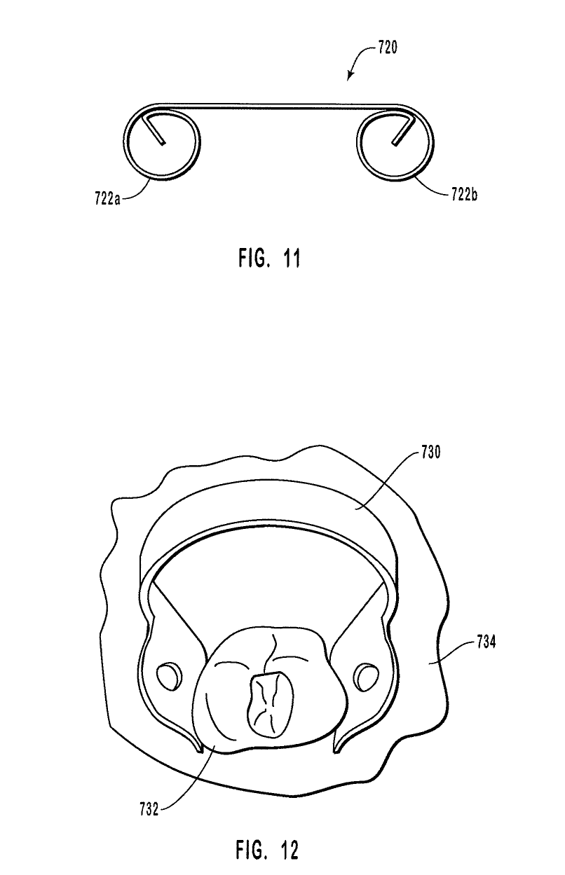

FIG. 11 illustrates an interproximal guard 720. Interproximal guard 720 is placed between teeth to protect an adjacent tooth from being damaged when the neighboring tooth is being worked on with an abrasive instrument, such as a burr or file. Guard ends 722a and 722b are curled to create spring-like ends, which abut the adjacent tooth and apply friction to keep guard 720 from falling off.

Guard 720 is made of the alloys described above. Consequently, guard 720 can be made very thin, which allows it to be more easily placed between teeth. In addition, the resilient nature of guard 720, due to the alloys of the present invention, allows guard 720 to better engage and disengage the adjacent tooth.

Turning now to FIG. 12, a rubber dam clamp 730 engages tooth 732 to hold rubber dam 734. Clamp 730 holds rubber dam 734, which serves as a barrier between tooth 732 and other teeth and/or other tissues in the oral cavity.

Clamp 730 is made of the alloys of the present invention. As a result, clamp 730 is made very thin, thus giving a practitioner more room to work around tooth 732. The super elastic nature of clamp 730 also allows clamp 730 to more easily engage and disengage tooth 732. The non-linear elastic modulus of clamp 730 also allows clamp 730 to have a more similar engagement force at different widths of separation. Consequently, clamp 730 can engage different sizes of teeth with more similar amounts of force, thus eliminating the need to have as many different sizes of clamps.

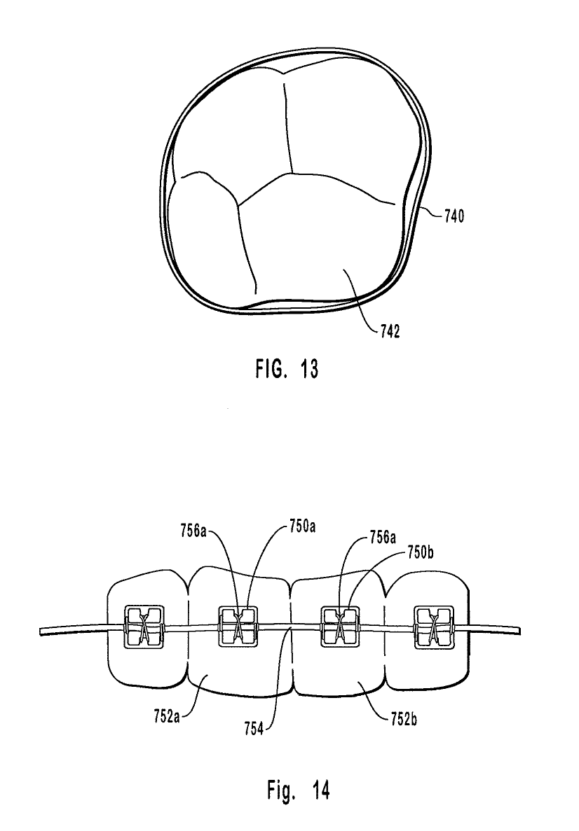

FIG. 13 shows a matrix band 740 according to the present invention. Matrix band 740 wraps around tooth 742 to form a mold for pouring a filling. Matrix band 740 is made from the super-elastic alloys of the present invention. Because the present alloys have very large tensile strength, matrix band 740 can be made very thin such that it more easily fits between adjacent teeth. The thinness of matrix band 740 enables the practitioner to form a filling with very little space between the filling and an adjacent tooth. Furthermore, the resilient nature of matrix band 740 provides a degree of spring in matrix band 740, thereby making it easier to remove matrix band 740 from tooth 742. In addition, band 740 is substantially free of nickel, thus providing a more biocompatible dental instrument. While band 740 has been described in the context of a matrix band, it should be understood that the present invention includes other bands such as orthodontic band.

Turning now to FIG. 14, in another embodiment, the dental devices of the present invention are dental brackets and arch wires. FIG. 14 shows a partial orthodontic bracket system. In an exemplary embodiment, dental brackets 750a and 750b are fixed to teeth 752a and 752b, respectively. Arch wire 754 spans brackets 750a and 750b and attaches with ligatures 756a and 756b respectively. Arch wire 754 anchors to an orthodontic band and applies tension to brackets 750a and 750b. The tension on brackets 750a and 750b moves respective teeth 752a and 752b over an extended period of time.

Brackets 750a and 750b and/or arch wire 754 are made from the super-elastic alloys of the present invention. Brackets 750a and 750b are very durable and resist deformation or breakage. Since arch wire 754 is made from the present alloys, it can also be made very thin and still maintain the tensile strength necessary to move teeth. Furthermore, because arch wire 754 is resilient, it is less likely to receive permanent kinks.

In an alternative embodiment, a portion of arch wire is looped to form a wire-like spring that interconnects two brackets. The spring-like wire applies a force to the interconnected brackets that is in a direction other than parallel with the dental arch.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method of manufacturing a dental instrument having high toughness, durability, resistance to work hardening, and biocompatibility, comprising:
forming an instrument body into a configuration for engaging dental tissue, the instrument body comprising:
a metal alloy composed of at least one group IV_{B} transition metal, at least one group V_{B} transition metal, and oxygen, the metal alloy being substantially free of nickel and characterized as having increased tensile strength, resistance to work hardening, and decreased elastic modulus of elasticity upon being cold worked; and
cold working the metal alloy to thereby increase tensile strength, provide resistance to work hardening, and decrease elastic modulus compared to the metal alloy before being cold worked,
the dental instrument possessing higher toughness, durability, resistance to work hardening, and biocompatibility compared to a dental instrument made of a nickel-titanium alloy.

2. A method as in claim 1, wherein cold working the metal alloy includes swaging with about a 25 percent reduction in area.

3. A method as in claim 1, wherein cold working the metal alloy includes swaging with about a 50 percent reduction in area.

4. A method as in claim 1, wherein cold working the metal alloy includes swaging with about a 75 percent reduction in area.

5. A method as in claim 1, wherein metal alloy includes titanium, tantalum, niobium, and zirconium and has a titanium content of less than about 35 mole percent.

6. A method as in claim 5, wherein metal alloy has a titanium content of less than about 15 mole percent.

7. A method as in claim 5, wherein metal alloy has an oxygen content in a range of about 0.1 to about 15.0 mole percent.

8. A method as in claim 5, wherein metal alloy has an oxygen content in a range of about 0.5 to about 10.0 mole percent.

9. A method as in claim 5, wherein the metal alloy has a composition in mole percent of about 1Ti-12Ta-9Nb-3V-6Zr-1O.

10. A method as in claim 5, wherein the metal alloy has a composition in mole percent of about 1Ti-23Nb-0.7Ta-2Zr-1O.

11. A method as in claim 1, wherein forming the instrument body includes forming an abrading segment on at least a portion of the instrument body for engaging dental tissue.

12. A method as in claim 11, wherein forming the abrading segment includes forming at least one flute and helical cutting edge that form at least a portion of an endodontic file.

13. A method as in claim 11, wherein the abrading segment forms at least a portion of a dental burr.

14. A method as in claim 11, wherein the abrading segment forms at least a portion of an abrasive disk.

15. A method as in claim 1, wherein the instrument body is formed into a dental implant, an inter-proximal guard, a rubber dam clamp, a matrix band, a dental bracket, or an arch wire.

16. A method of manufacturing an endodontic file having high toughness, durability, resistance to work hardening, and biocompatibility, comprising:
forming a shaft having a periphery surface, at least a portion of the periphery surface providing an abrading segment configured for abrading a root canal of a tooth, the shaft comprising:
a metal alloy composed of at least one group IV_{B} transition metal, at least one group V_{B} transition metal, and oxygen, the metal alloy being substantially free of nickel, having a titanium content of less than about 35%, and characterized as having increased tensile strength, resistance to work hardening, and decreased elastic modulus of elasticity upon being cold worked; and
cold working the metal alloy to thereby increase tensile strength, provide resistance to work hardening, and decrease elastic modulus compared to the metal alloy before being cold worked,
the shaft possessing higher toughness, durability, resistance to work hardening, and biocompatibility compared to a shaft made of a nickel-titanium alloy.

17. A method as in claim 16, wherein metal alloy includes titanium, tantalum, niobium, and zirconium and has a titanium content of less than about 15 mole percent and an oxygen content in a range of about 0.1 to about 15.0 mole percent.

18. A method as in claim 16, wherein forming the shaft includes forming at least one flute and helical cutting edge.

19. A method of manufacturing an endodontic file having high toughness, durability, resistance to work hardening, and biocompatibility, comprising:
forming a shaft having a periphery surface, at least a portion of the periphery surface providing including at least one flute and helical cutting edge configured for abrading a root canal of a tooth, the shaft comprising:
a metal alloy composed of titanium, tantalum, niobium, zirconium, and oxygen, the metal alloy being substantially free of nickel, having a titanium content of less than about 35 mole percent, and characterized as having increased tensile strength, resistance to work hardening, and decreased elastic modulus of elasticity upon being cold worked; and
cold working the metal alloy to thereby increase tensile strength, provide resistance to work hardening, and decrease elastic modulus compared to the metal alloy before being cold worked,
the shaft possessing higher toughness, durability, resistance to work hardening, and biocompatibility compared to a shaft made of a nickel-titanium alloy.

20. A method as in claim 19, wherein the titanium content of the metal alloy is less than about 15 mole percent.

21. A method as in claim 19, wherein the titanium content of the metal alloy is less than about 5 mole percent.

22. A method as in claim 19, wherein cold working the metal alloy includes swaging with about a 40 percent reduction in area.

23. A method as in claim 19, wherein the metal alloy has a composition in mole percent of about 1Ti-12Ta-9Nb-3V-6Zr-1O.

24. A method as in claim 19, wherein the metal alloy has a composition in mole percent of about 1Ti-23Nb-0.7Ta-2Zr-1O.
